(19) United States
(12) Patent Application Publication
(10) Pub. No.: US 2025/0391401 A1
(43) Pub. Date: Dec. 25, 2025

(54) MODEL GENERATION DEVICE, MODEL GENERATION METHOD, SIGNAL PROCESSING DEVICE, SIGNAL PROCESSING METHOD, AND PROGRAM

(71) Applicant: SONY GROUP CORPORATION, TOKYO (JP)

(72) Inventor: YUICHIRO KOYAMA, TOKYO (JP)

(21) Appl. No.: 18/878,730

(22) PCT Filed: Jun. 20, 2023
(86) PCT No.: PCT/JP2023/022683

§ 371 Date: Dec. 24, 2024

(30) Foreign Application Priority Data
Jul. 7, 2022 (JP) 2022-109857

(51) Int. Cl. G10L 15/16; G06N 3/096

(52) U.S. Cl. CPC G10L 15/16; G06N 3/096

(57) ABSTRACT

The present technology relates to a model generation device, a model generation method, a signal processing device, a signal processing method, and a program capable of suppressing useless calculation and independently adjusting performance of signal processing. A learning unit learns a transferable learning model, transfers a part of the learning model to another transferable learning model, and learns a non-transfer portion other than a transfer portion of the another learning model. A combination unit generates a combined model in which the non-transfer portion of the another learning model is combined with the learning model. The present technology can be applied to, for example, a case of generating a learning model that performs a plurality of pieces of signal processing.

### TECHNICAL FIELD

The present technology relates to a model generation device, a model generation method, a signal processing device, a signal processing method, and a program, and particularly relates to, for example, a model generation device, a model generation method, a signal processing device, a signal processing method, and a program capable of suppressing useless calculation and independently adjusting performance of signal processing.

### BACKGROUND ART

Patent Document 1 describes a multi-task deep neural network (DNN) in which some layers of each of a plurality of DNNs are shared layers that share model parameters (model variables).

### CITATION LIST

### Patent Document

Patent Document 1: International Publication No. 2019/198814

### SUMMARY OF THE INVENTION

### Problems to be Solved by the Invention

In the multi-task DNN described in Patent Document 1, since the model parameters of the shared layer are shared, it is possible to improve the efficiency of the calculation for executing the plurality of tasks as compared with the case of using the plurality of DNNs independent for each task (function and signal processing).

For example, in a case where the plurality of DNNs independent for each task is used, similar calculation, that is, calculation using the same or substantially the same model parameters may be performed in some layers of the plurality of DNNs. Performing calculation similar to a certain DNN in another DNN is useless, and performing such useless calculation increases an overall calculation amount.

In the multi-task DNN described in Patent Document 1, it is possible to suppress useless calculation.

However, learning of the multi-task DNN requires complicated optimization based on multi-task learning, and it is difficult to independently adjust performance of a task, and a task with insufficient performance may occur.

The present technology has been made in view of such a situation, and an object of the present technology is to suppress useless calculation and to independently adjust performance of a task, that is, signal processing.

### Solutions to Problems

A model generation device or a first program of the present technology is a model generation device including: a learning unit that learns a transferable learning model, transfers a part of the learning model to another transferable learning model, and learns a non-transfer portion other than a transfer portion of the another learning model; and a combination unit that generates a combined model in which the non-transfer portion of the another learning model is combined with the learning model, or a program for causing a computer to function as such a model generation device.

A model generation method of the present technology is a model generation method including: performing learning of a transferable learning model; transferring a part of the learning model to another transferable learning model, and performing learning of a non-transfer portion other than a transfer portion of the another learning model; and generating a combined model in which the non-transfer portion of the another learning model is combined with the learning model.

In the model generation device, the model generation method, and the first program of the present technology, learning of the transferable learning model is performed. Moreover, a part of the learning model is transferred to the another transferrable learning model, and learning of the non-transfer portion other than the transfer portion of the another learning model is performed. Then, a combined model obtained by combining the non-transfer portion of the another learning model with the learning model is generated.

A signal processing device or a second program of the present technology is a signal processing device including a signal processing unit that performs signal processing using a combined model obtained by combining a non-transfer portion other than a transfer portion of another transferable learning model with a transferrable learning model, the non-transfer portion having been learned by transferring a part of the transferable learning model to the another transferable learning model, or a program for causing a computer to function as such a signal processing device.

A signal processing method according to the present technology is a signal processing method including performing signal processing using a combined model obtained by combining a non-transfer portion other than a transfer portion of another transferable learning model with a transferrable learning model, the non-transfer portion having been learned by transferring a part of the transferable learning model to the another transferable learning model.

In the signal processing device, the signal processing method, and the second program of the present technology, the signal processing is performed using the combined model obtained by combining the non-transfer portion other than the transfer portion of the another transferable learning model with the transferrable learning model, the non-transfer portion having been learned by transferring a part of the transferable learning model to the another transferable learning model.

Each of the model generation device and the signal processing device may be an independent device or an internal block constituting one device.

Furthermore, the program may be provided by being transmitted through a transmitting medium or being recorded in a recording medium.

### BRIEF DESCRIPTION OF DRAWINGS

FIG. 1 is a block diagram illustrating a first configuration example of a multi-signal processing device.

FIG. 2 is a block diagram illustrating a second configuration example of the multi-signal processing device.

FIG. 3 is a block diagram illustrating a third configuration example of the multi-signal processing device.

FIG. 4 is a block diagram illustrating a configuration example of an embodiment of a model generation device to which the present technology is applied.

FIG. 5 is a flowchart illustrating an example of a model generation process of generating a combined model performed by a model generation device 40.

FIG. 6 is a diagram illustrating an example of learning of a learning model by a learning unit 42.

FIG. 7 is a diagram illustrating an example of generation of a combined model by a combination unit 44.

FIG. 8 is a diagram illustrating another example of learning of a learning model by the learning unit 42.

FIG. 9 is a diagram illustrating an example of adjustment of performance of signal processing performed by a combined model.

FIG. 10 is a diagram illustrating specific examples of a transfer portion and a non-transfer portion.

FIG. 11 is a diagram illustrating another example of the adjustment of the performance of the signal processing performed by the combined model.

FIG. 12 is a diagram illustrating an example of generation of a new combined model by adding a non-transfer portion of another learning model to the combined model.

FIG. 13 is a diagram for explaining an example of generating a combined model for each type of signal targeted by target information.

FIG. 14 is a block diagram illustrating a configuration example of an embodiment of a multi-signal processing device to which the present technology is applied.

FIG. 15 is a flowchart illustrating an example of a process of the multi-signal processing device 110.

FIG. 16 is a block diagram illustrating a configuration example of an embodiment of a computer to which the present technology is applied.

### MODE FOR CARRYING OUT THE INVENTION

### First Configuration Example of Multi-Signal Processing Device

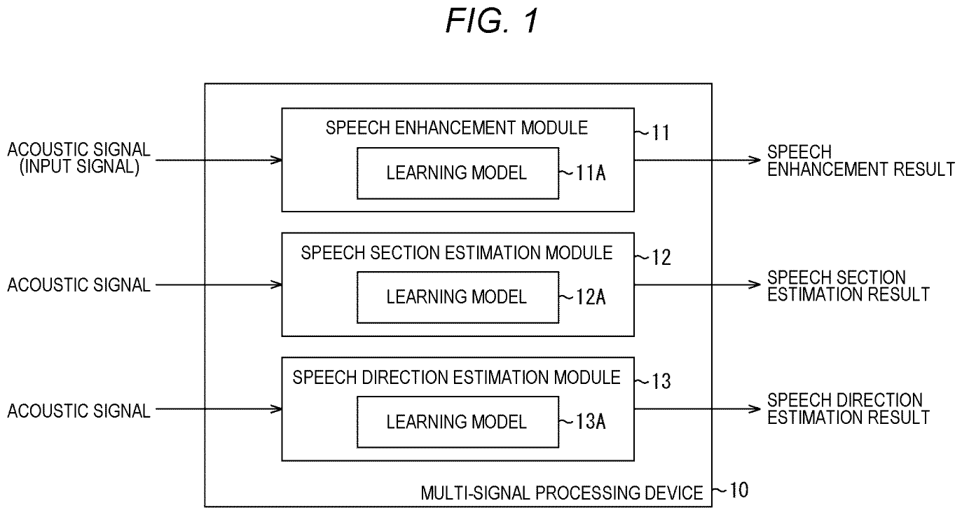

FIG. 1 is a block diagram illustrating a first configuration example of a multi-signal processing device.

The multi-signal processing device is a device that performs a plurality of (types of) signal processing using a learning model as a task (function) of generating target information to be a target from an input signal, that is, signal processing (information processing).

Here, in order to make the description easy to understand, for example, an acoustic signal output from a sound collecting device capable of collecting sound such as a microphone is adopted as the input signal. Furthermore, as a plurality of signal processing, for example, three signal processing of speech enhancement processing, speech section estimation processing, and speech direction estimation processing are adopted.

As the sound collecting device, a device having one or more microphones can be adopted. In a case where the speech direction estimation processing is performed, it is desirable to employ a sound collecting device having two or more microphones.

The speech enhancement processing is processing of removing a non-speech component (noise component) other than a speech (human voice) component from the acoustic signal and generating information of a signal (Ideally, it is a signal of only a speech component, and hereinafter also referred to as an acoustic signal.) in which the speech component is enhanced as target information.

The speech section estimation processing is processing of generating, from an acoustic signal, information of a speech section in which a speech signal exists, that is, a speech section in which a speech component is included in the acoustic signal, as target information. As the information of the speech section, for example, a start position (time) and an end position of the speech section can be employed. Furthermore, as the information of the speech section, information that can be easily converted into the start position and the end position of the speech section, for example, the likelihood that the speech signal exists, the volume (power) of the speech signal, and the like can be adopted.

The speech direction estimation processing is processing of generating, from the acoustic signal, information of an arrival direction (speech direction) in which speech arrives as target information. As the information of the arrival direction, for example, a direction of a sound source (person or the like) of a sound expressed by a predetermined coordinate system with a position of a sound collecting device that outputs an acoustic signal as an origin, or the like can be adopted.

In FIG. 1, a multi-signal processing device 10 includes a speech enhancement module 11, a speech section estimation module 12, and a speech direction estimation module 13. The multi-signal processing device 10 performs three types of signal processing, that is, speech enhancement processing, speech section estimation processing, and speech direction estimation processing, on the acoustic signal.

The speech enhancement module 11 includes, for example, a learning model 11A that is a neural network such as a deep neural network (DNN) or another mathematical models. The learning model 11A is a learned learning model that receives an acoustic signal (a feature amount of the acoustic signal) as an input and outputs information on a speech signal (a speech component) included in the acoustic signal.

The speech enhancement module 11 inputs an acoustic signal to the learning model 11A, and outputs information (for example, an audio signal in a time domain, a spectrum of the audio signal, or the like.) of the speech signal output from the learning model 11A in response to the input of the acoustic signal as a speech enhancement result.

The speech section estimation module 12 includes, for example, a learning model 12A that is a neural network or another mathematical model. The learning model 12A is a learned learning model that receives an acoustic signal (a feature amount of the acoustic signal) as an input and outputs information of a speech section in the acoustic signal.

The speech section estimation module 12 inputs an acoustic signal to the learning model 12A, and outputs information of the speech section output by the learning model 12A in response to the input of the acoustic signal as a speech section estimation result.

The speech direction estimation module 13 includes, for example, a learning model 13A that is a neural network or another mathematical model. The learning model 13A is a learned learning model that receives an acoustic signal (a feature amount of the acoustic signal) as an input and outputs information on an arrival direction of a speech component in the acoustic signal.

The speech direction estimation module 13 inputs an acoustic signal to the learning model 13A, and outputs information on the arrival direction output by the learning model 13A with respect to the input of the acoustic signal as a speech direction estimation result.

Here, for example, in an entertainment robot or a product having an agent function, it is required to perform advanced behavior with respect to an acoustic signal output from a microphone, and it is necessary to perform a plurality of tasks as tasks with respect to the acoustic signal. Regarding the entertainment robot and the like, three tasks of speech enhancement (noise suppression) processing, a speech section estimation processing, and a speech direction estimation processing are particularly basic and important as a plurality of tasks (signal processing) for the acoustic signal.

Therefore, the multi-signal processing device that performs the speech enhancement processing, the speech section estimation processing, and the speech direction estimation processing as in the multi-signal processing device 10 in FIG. 1 is particularly useful for an entertainment robot or the like.

In the multi-signal processing device 10 of FIG. 1, each of the modules for performing the speech enhancement processing, the speech section estimation processing, and the speech direction estimation processing is independently prepared as an individual speech enhancement module 11, a speech section estimation module 12, and a speech direction estimation module 13. That is, learning models for performing the speech enhancement processing, the speech section estimation processing, and the speech direction estimation processing are independently prepared as learning models 11A, 12A, and 13A, respectively.

Therefore, the performance of each task (signal processing) of the speech enhancement processing, the speech section estimation processing, and the speech direction estimation processing can be adjusted (optimized, or the like) independently by individual adjustment (tuning) of each of the learning models 11A, 12A, and 13A.

However, each of the learning models 11A, 12A, and 13A is a learning model that receives an acoustic signal as an input and outputs information regarding a speech signal as target information. Therefore, some of the calculations using (performed using) each of the learning models 11A, 12A, and 13A are similar calculations.

In the multi-signal processing device 10, in the calculation using each of the learning models 11A, 12A, and 13A, the similar calculation is partially performed, and thus, useless calculation (overlapping calculation) occurs and the overall calculation amount increases.

Therefore, it is difficult to mount the multi-signal processing device 10 on an edge device such as an entertainment robot having few resources from the viewpoint of the amount of calculation.

On the other hand, for example, by adopting a learning model having a simple structure as the learning models 11A, 12A, and 13A, it is possible to reduce the overall calculation amount of the calculation using each of the learning models 11A, 12A, and 13A.

However, in a case where a learning model having a simple structure is adopted as the learning models 11A, 12A, and 13A, performance of signal processing performed by the learning models 11A, 12A, and 13A is deteriorated, and sufficient performance may not be obtained.

Therefore, in a case where the multi-signal processing device 10 is mounted on an edge device such as an entertainment robot, there is a problem of trade-off between the amount of calculation and performance.

### Second Configuration Example of Multi-Signal Processing Device

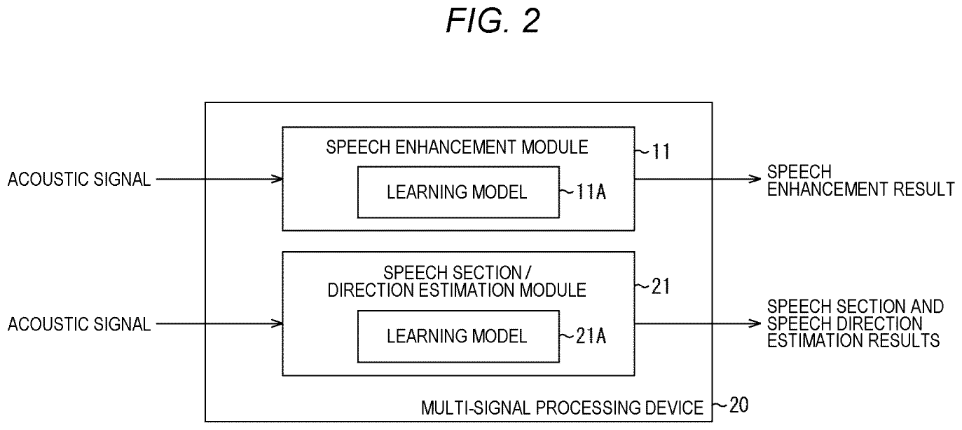

FIG. 2 is a block diagram illustrating a second configuration example of the multi-signal processing device.

Note that, in the drawing, a portion corresponding to that in FIG. 1 is assigned with the same reference sign, and description thereof is hereinafter appropriately omitted.

In FIG. 2, the multi-signal processing device 20 includes a speech enhancement module 11 and a speech section/direction estimation module 21. Similarly to the multi-signal processing device 10 of FIG. 1, the multi-signal processing device 20 performs three types of signal processing of a speech enhancement processing, a speech section estimation processing, and a speech direction estimation processing on the acoustic signal.

The multi-signal processing device 20 is common to the multi-signal processing device 10 in FIG. 1 in that it includes a speech enhancement module 11. However, the multi-signal processing device 20 is different from the multi-signal processing device 10 in including a speech section/direction estimation module 21 instead of the speech section estimation module 12 and the speech direction estimation module 13.

The speech section/direction estimation module 21 includes, for example, a learning model 21A that is a neural network or another mathematical model. The learning model 21A is a learned learning model that receives an acoustic signal (a feature amount of the acoustic signal) as an input and outputs information of both a speech section and an arrival direction in the acoustic signal. Therefore, the learning model 21A is a learning model that performs a plurality of pieces of signal processing, that is, two pieces of signal processing of the speech section estimation processing and the speech direction estimation processing.

The speech section/direction estimation module 21 inputs an acoustic signal to the learning model 21A, and outputs information of both the speech section and the arrival direction output by the learning model 21A with respect to the input of the acoustic signal as a speech section and a speech direction estimation result.

Here, the present inventor has previously proposed a technique of simultaneously estimating a speech section and an arrival direction by using a learning model that adopts a vector (three-dimensional vector) as an expression format of information that is a so-called superset including information of the speech section and information of the arrival direction, and outputs a vector including information of the speech section and information of the arrival direction with respect to an input of an acoustic signal. Such a technique is described in International Publication No. 2020/250797 (Hereinafter, also referred to as Document A.), SHIMADA, Kazuki, et al. Accdoa: Activity-coupled cartesian direction of arrival representation for sound event localization and detection. In: ICASSP 2021-2021 IEEE International Conference on Acoustics, Speech and Signal Processing (ICASSP). IEEE, 2021. p. 915-919.

The learning model 21A is, for example, a learning model using the technology of Document A, and outputs a vector including information on a speech section and an arrival direction in an acoustic signal with the acoustic signal as an input.

Therefore, in the multi-signal processing device 20, regarding the speech section estimation processing and the speech direction estimation processing, useless calculation does not occur for calculation using the learning model 21A.

However, between the speech enhancement processing, the speech section estimation processing, and the speech direction estimation processing, a similar calculation partially exists between the calculation using the learning model 11A and the calculation using the learning model 21A. Therefore, in the multi-signal processing device 20, although not as much as the multi-signal processing device 10, useless calculation also occurs.

Furthermore, regarding the multi-signal processing device 20, the performance of the speech enhancement processing can be independently adjusted by adjusting the learning model 11A, but it is difficult to independently adjust the performance of the speech section estimation processing and the speech direction estimation processing.

### Third Configuration Example of Multi-Signal Processing Device

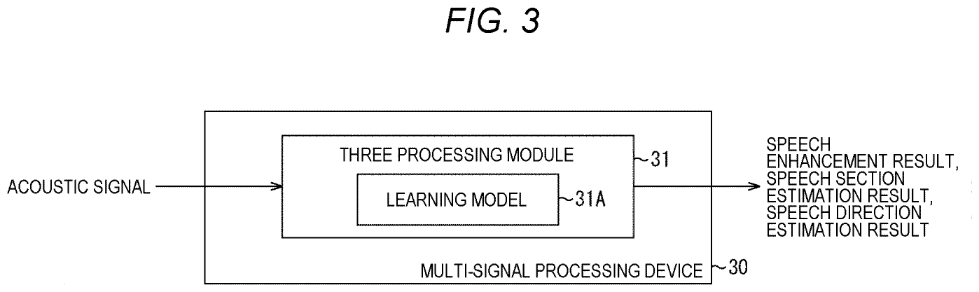

FIG. 3 is a block diagram illustrating a third configuration example of the multi-signal processing device.

In FIG. 3, a multi-signal processing device 30 includes three processing module 31. Similarly to the multi-signal processing device 10 of FIG. 1, the multi-signal processing device 30 performs three types of signal processing of speech enhancement processing, speech section estimation processing, and speech direction estimation processing on the acoustic signal.

The three processing module 31 includes, for example, a learning model 31A that is a neural network or another mathematical model. The learning model 31A is a learned learning model that receives an acoustic signal (a feature amount of the acoustic signal) as an input and outputs information on a speech signal, a speech section, and an arrival direction included in the acoustic signal. Therefore, the learning model 31A is a learning model that performs a plurality of pieces of signal processing, that is, three pieces of signal processing of the speech enhancement processing, the speech section estimation processing, and the speech direction estimation processing.

The three processing module 31 inputs the acoustic signal to the learning model 31A, and outputs information on the speech signal, the speech section, and the arrival direction output by the learning model 31A with respect to the input of the acoustic signal as the speech enhancement result, the speech section estimation result, and the speech direction estimation result.

Here, Document A describes a technique of simultaneously performing three signal processing of speech enhancement processing, speech section estimation processing, and speech direction estimation processing using a learning model that outputs a vector including information of a speech signal, a speech section, and an arrival direction with respect to an input of an acoustic signal.

The learning model 31A is, for example, a learning model using the technology of Document A, and outputs a vector as information of a speech signal, a speech section, and an arrival direction with an acoustic signal as an input.

Therefore, in the multi-signal processing device 30, useless calculation that occurs in the multi-signal processing devices 10 and 20 does not occur.

Meanwhile, in an actual development site, with progress of development or the like, there is a case where it is desired to independently and individually adjust the performance of one of the speech enhancement processing, the speech section estimation processing, and the speech direction estimation processing, or the performance of each of the plurality of signal processing.

However, for the learning model 31A, it is difficult to independently adjust the performance of one of the speech enhancement processing, the speech section estimation processing, and the speech direction estimation processing or the performance of each of the plurality of pieces of signal processing.

That is, with respect to the learning model 31A that outputs a speech signal, a speech section, and a vector as information of an arrival direction using an acoustic signal as an input, when learning (relearning or joint training) or the like of the learning model 31A is performed so as to improve the performance of one of the speech enhancement processing, the speech section estimation processing, and the speech direction estimation processing, for example, the performance of the speech section estimation processing and the speech direction estimation processing also change.

Note that a learning model that performs a plurality of pieces of signal processing such as the learning model 21A (FIG. 2) and the learning model 31A (FIG. 3) includes, for example, a learning model generated by general multi-task learning in addition to the learning model generated by the technology described in Document A.

Even in the learning model generated by general multi-task learning, similarly to the learning model 31A, it is difficult to independently adjust the performance of one of the plurality of signal processing or the performance of each of the plurality of signal processing.

Moreover, for a learning model generated by general multi-task learning, it is difficult to design a loss function, and performance of each of a plurality of pieces of signal processing may be insufficient.

<One Embodiment of Model Generation Device to which Present Technology is Applied>

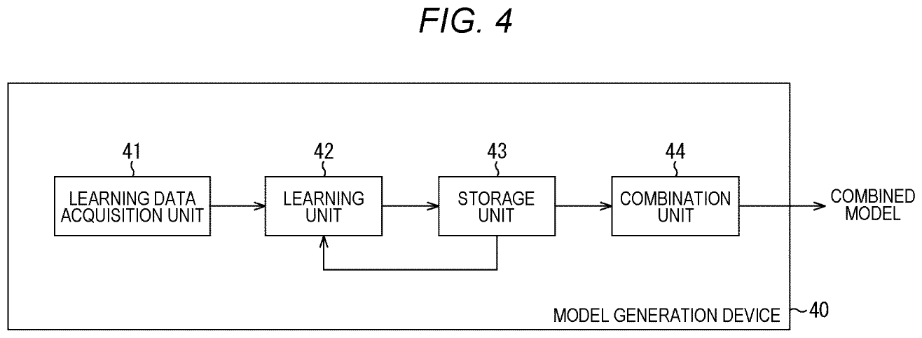

FIG. 4 is a block diagram illustrating a configuration example of an embodiment of a model generation device to which the present technology is applied.

In FIG. 4, a model generation device 40 includes a learning data acquisition unit 41, a learning unit 42, a storage unit 43, and a combination unit 44, and generates a combined model as a learning model that performs a plurality of pieces of signal processing performed by the multi-signal processing device.

The learning data acquisition unit 41 acquires learning data used for learning in the learning unit 42 and supplies the learning data to the learning unit 42.

For example, for learning of (a learning model that performs) the speech enhancement processing, an acoustic signal to be an input of the learning model and (information on) a speech signal to be output to the acoustic signal are acquired as learning data. The learning data can be acquired by any method such as downloading from a server on the Internet.

The learning unit 42 learns a plurality of transferrable learning models by using the learning data from the learning data acquisition unit 41. As the transferrable learning model, for example, a neural network can be adopted, but it is not limited to the neural network.

For example, the learning unit 42 learns a learning model for performing certain signal processing, for example, speech enhancement processing. The learning unit 42 supplies (the model parameters of) the learning model for performing the speech enhancement processing (after learning) to the storage unit 43 and stores the model parameters.

Moreover, the learning unit 42 transfers the transfer portion, which is a part of the learning model for performing the speech enhancement processing stored in the storage unit 43, to another signal processing, for example, a learning model for performing the speech section estimation processing or the speech direction estimation processing, and learns a non-transfer portion other than the transfer portion of the learning model.

In the learning of the non-transfer portion of the learning model, the model parameters of the non-transfer portion are learned (calculated) while fixing the model parameters of the transfer portion of the learning model.

The learning unit 42 supplies (the model parameters of) the non-transfer portion of the learning model that performs another signal processing (after learning) to the storage unit 43 to store.

The learning unit 42 can perform transfer of a transfer portion and learning of a non-transfer portion for an arbitrary number of learning models for further performing another signal processing.

The storage unit 43 stores one learning model supplied from the learning unit 42 and (model parameters of) the non-transfer portion of one or more another learning models.

The combination unit 44 combines the non-transfer portions of one or more another learning models also stored in the storage unit 43 with the transfer portion of one learning model stored in the storage unit 43, thereby generating and outputting a combined model obtained by combining the non-transfer portions of the another learning model with one learning model.

### <Model Generation Process>

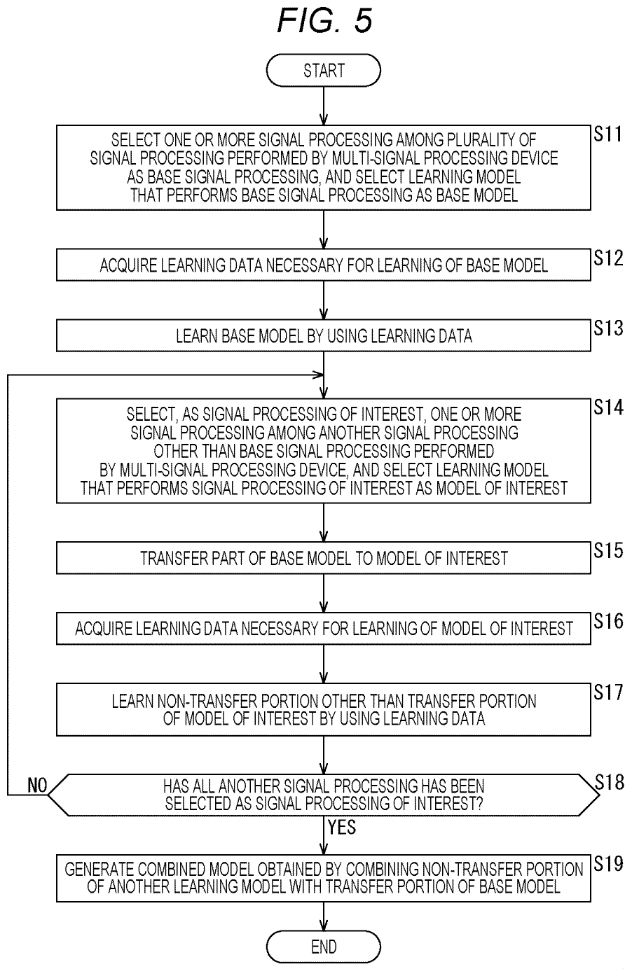

FIG. 5 is a flowchart illustrating an example of a model generation process of generating a combined model performed by the model generation device 40 in FIG. 4.

In step S11, the learning unit 42 selects one or more (not all) signal processing among the plurality of signal processing performed by the multi-signal processing device as the base signal processing. Moreover, the learning unit 42 selects the learning model that performs the base signal processing as the base model, and the processing proceeds from step S11 to step S12.

In step S12, the learning data acquisition unit 41 acquires learning data necessary for learning of the base model and supplies the learning data to the learning unit 42, and the process proceeds to step S13.

In step S13, the learning unit 42 learns the base model by using the learning data from the learning data acquisition unit 41. The learning unit 42 supplies the learned base model to the storage unit 43 to store, and the process proceeds from step S13 to step S14.

In step S14, the learning unit 42 selects, as the signal processing of interest, one or more pieces of signal processing among another signal processing other than the base signal processing performed by the multi-signal processing device. Moreover, the learning unit 42 selects the learning model that performs the signal processing of interest as the model of interest, and the process proceeds from step S14 to step S15.

In step S15, the learning unit 42 transfers the transfer portion, which is a part of the base model stored in the storage unit 43, to the model of interest, and the process proceeds to step S16.

In step S16, the learning data acquisition unit 41 acquires learning data necessary for learning of the model of interest and supplies the learning data to the learning unit 42, and the process proceeds to step S17.

In step S17, the learning unit 42 learns the non-transfer portion other than the transfer portion of the model of interest by using the learning data from the learning data acquisition unit 41. The learning unit 42 supplies the non-transfer portion of the learned model of interest to the storage unit 43 to store, and the process proceeds from step S17 to step S18.

In step S18, the learning unit 42 determines whether or not all the another signal processing has been selected as the signal processing of interest, and in a case where it is determined that all the another signal processing has not yet been selected as the signal processing of interest, the process returns to step S14.

In step S14, one or more pieces of signal processing that have not yet been selected as the signal processing of interest among the another signal processing are newly selected as the signal processing of interest, and the similar processing is repeated thereafter.

On the other hand, in a case where it is determined in step S18 that all the another signal processing has been selected for the signal processing of interest, the process proceeds to step S19.

In step S19, the combination unit 44 generates and outputs a combined model obtained by combining a non-transfer portion of another learning model with a transfer portion of the base model stored in the storage unit 43, and the process ends.

### <Example of Learning of Learning Model by Learning Unit 42>

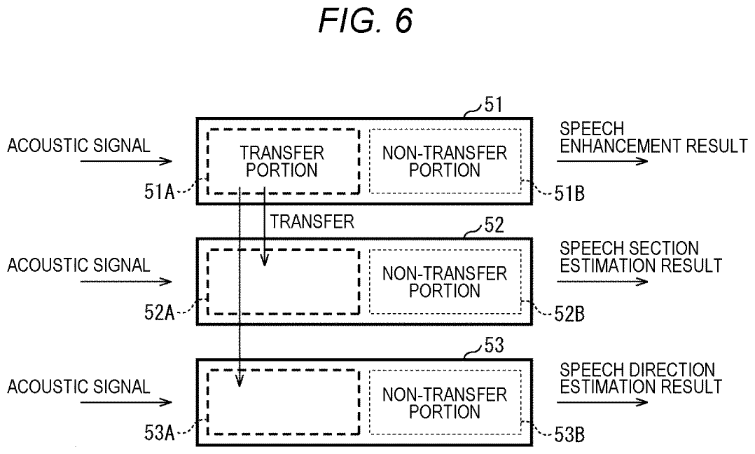

FIG. 6 is a diagram illustrating an example of learning of the learning model by the learning unit 42.

FIG. 6 illustrates a state of learning of the learning model.

For example, it is assumed that the multi-signal processing device performs three types of signal processing: speech enhancement processing, speech section estimation processing, and speech direction estimation processing.

In the model generation process of FIG. 5, the learning unit 42 selects, for example, speech enhancement processing, which is one of the speech enhancement processing, the speech section estimation processing, and the speech direction estimation processing, as base signal processing. Moreover, the learning unit 42 selects the learning model 51 for performing the speech enhancement processing as the base signal processing as the base model, and learns the learning model 51 for performing the speech enhancement processing as the base model. The learning of the learning model 51 is performed by giving learning data to inputs and outputs of the learning model 51.

The learning unit 42 selects, as signal processing of interest, the speech section estimation processing, for example, that is one signal processing of the speech section estimation processing and the speech direction estimation processing, which are another signal processing other than the base signal processing. Moreover, the learning unit 42 selects, as a model of interest, the learning model 52 that performs the speech section estimation processing as signal processing of interest.

The learning unit 42 sets a part of the learning model 51 that performs the speech enhancement processing as the base model, for example, the first half portion on the input layer side of the neural network as the learning model that performs the speech enhancement processing as the transfer portion 51A, sets a portion other than the transfer portion as the non-transfer portion 51B, and transfers the transfer portion 51A as the transfer portion 52A of the learning model 52 that performs the speech section estimation processing as the model of interest.

Then, the learning unit 42 learns the non-transfer portion 52B other than the transfer portion 52A of the learning model 52 that performs the speech section estimation processing as the model of interest.

The learning of the non-transfer portion 52B of the learning model 52 is performed by giving learning data to inputs and outputs of the learning model 52 and fixing (model parameters of) the transfer portion 52A of the learning model 52.

Thereafter, the learning unit 42 selects, as the signal processing of interest, the speech direction estimation processing that is not selected as the signal processing of interest, among the speech section estimation processing and the speech direction estimation processing that are another signal processing than the base signal processing. Moreover, the learning unit 42 selects the learning model 53 that performs the speech direction estimation processing as the signal processing of interest as the model of interest.

The learning unit 42 transfers the transfer portion 51A of the learning model 51 that performs the speech enhancement processing as the base model as the transfer portion 53A of the learning model 53 that performs the speech direction estimation processing as the model of interest.

Then, the learning unit 42 learns the non-transfer portion 53B other than the transfer portion 53A of the learning model 53 that performs the speech section estimation processing as the model of interest.

The learning of the non-transfer portion 53B of the learning model 53 is performed by giving learning data to the input and output of the learning model 53 and fixing the transfer portion 53A of the learning model 53.

The learning of the learning model 51, (the non-transfer portion 52B of) the learning model 52, and (the non-transfer portion 53B of) the learning model 53 is performed independently. Therefore, it is possible to perform appropriate learning so as to obtain necessary performance for each of the speech enhancement processing, the speech section estimation processing, and the speech direction estimation processing performed by the learning models 51 to 53.

After learning the learning model 51, the non-transfer portion 52B of the learning model 52, and the non-transfer portion 53B of the learning model 53, the combination unit 44 combines the non-transfer portions 52B and 53B with the transfer portion 51A of the learning model 51. As a result, a combined model in which the non-transfer portion 52B of the learning model 52 and the non-transfer portion 53B of the learning model 52 are combined with the learning model 51 is generated.

Note that, here, the learning model 51 for performing the speech enhancement processing among the speech enhancement processing, the speech section estimation processing, and the speech direction estimation processing as the plurality of signal processing performed by the multi-signal processing device is selected as the base model, that is, the learning model to be the transfer source of the transfer portion.

As the base model, a learning model that performs signal processing other than the speech enhancement processing, that is, the learning model 52 that performs the speech section estimation processing or the learning model 53 that performs the speech direction estimation processing can be adopted.

However, it is desirable to adopt, as the base model, a learning model (Hereinafter, it is also referred to as an information amount maximum model.) that outputs a larger amount of information than another learning models among learning models that perform a plurality of pieces of signal processing performed by the multi-signal processing device.

This is because, in the information amount maximum model, the lack of the information amount in the transfer portion is small, and in a case where the transfer portion is transferred to another learning model, the influence of the transfer on the output of the another learning model (the influence on the performance of the signal processing performed by the another learning model) can be reduced or almost eliminated.

The learning models 51 to 53 are learning models that output information of a speech signal, a speech section, and an arrival direction in response to an input of an acoustic signal.

Therefore, among the learning models 51 to 53, since the information of the speech signal output from the learning model 51 that performs the speech enhancement processing has the largest amount of information, it is desirable to select the learning model 51 as the base model to be the transfer source of the transfer portion.

### <Example of Generation of Combined Model by Combination Unit 44>

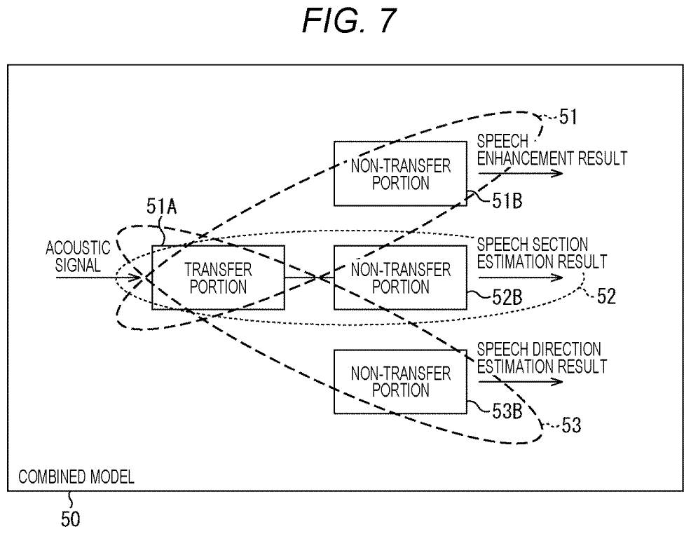

FIG. 7 is a diagram illustrating an example of generation of a combined model by the combination unit 44.

For example, as described in FIG. 6, in a case where the learning unit 42 learns the learning model 51, the non-transfer portion 52B of the learning model 52, and the non-transfer portion 53B of the learning model 53, the combination unit 44 combines the non-transfer portions 52B and 53B with the transfer portion 51A of the learning model 51.

As a result, the combined model 50 in which the non-transfer portion 52B of the learning model 52 and the non-transfer portion 53B of the learning model 52 are combined with the learning model 51 is generated.

The combined model 50 includes the transfer portion 51A equal to the transfer portions 52A and 53A, and non-transfer portions 51B to 53B.

In the combined model 50, the transfer portion 51A and the non-transfer portion 51B constitute the learning model 51 that performs speech enhancement processing. Then, the transfer portion 51A and the non-transfer portion 52B constitute the learning model 52 that performs the speech section estimation processing, and the transfer portion 51A and the non-transfer portion 53B constitute the learning model 53 that performs the speech direction estimation processing.

In the combined model 50, since (the model parameters of) the transfer portion 51A is shared by the three learning models 51 to 53 as a plurality, it is possible to suppress useless calculation and independently adjust the performance of each of the plurality of signal processing.

That is, in the signal processing using the combined model 50, it is possible to suppress useless calculation performed by the multi-signal processing device 10 (FIG. 1) and to reduce the overall calculation amount as compared with the cases of FIGS. 1 and 2.

For example, in the case of FIG. 1, it is necessary to calculate the transfer portions 51A to 53A and the non-transfer portions 51B to 53B in FIG. 6.

On the other hand, in the combined model 50, the entire calculation amount can be reduced by the calculation of the transfer portions 51A and the non-transfer portions 51B to 53B and the calculation of the transfer portions 52A and 53A.

Moreover, the performance of each of the speech enhancement processing performed by the learning model 51, the speech section estimation processing performed by the learning model 52, and the speech direction estimation processing performed by the learning model 53 can be independently adjusted by adjusting each of the non-transfer portions 51B to 53B.

That is, for example, in a case where it is desired to improve the performance of the speech enhancement processing, by adjusting the non-transfer portion 51B, only the performance of the speech enhancement processing can be improved without changing the performance of the speech section estimation processing and the speech direction estimation processing.

Here, the adjustment of the non-transfer portion of the learning model means that, in the learning unit 42, learning data is given to inputs and outputs of the learning model, the transfer portion of the learning model is fixed, and relearning or joint training of the non-transfer portion (model parameters thereof) is performed. The joint training includes changing the structure of the non-transfer portion, for example, when the learning model is a neural network, the number of layers, the number of nodes of the layers, and the like.

Note that learning of a learning model that shares some model parameters and performs a plurality of tasks (signal processing) such as the combined model 50 in FIG. 7 can be performed by multi-task learning. However, the multi-task learning requires trial and error for defining a loss function and adjusting a loss weight (balance) of each task, and an effective method has not been established.

The model generation device 40 in FIG. 4 can easily generate a combined model that shares some model parameters and performs a plurality of tasks by using transfer of learning models without performing the multi-task learning.

### <Another Example of Learning of Learning Model by Learning Unit 42>

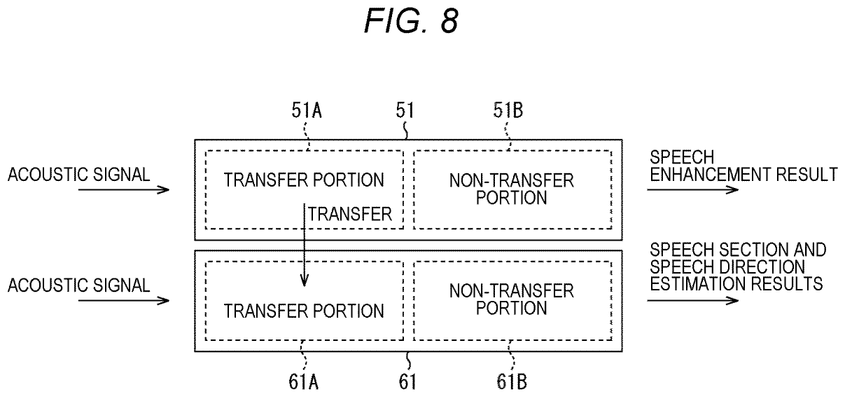

FIG. 8 is a diagram illustrating another example of learning of the learning model by the learning unit 42.

FIG. 8 illustrates a state of learning of the learning model.

Note that, in the drawing, a portion corresponding to that in FIG. 6 is assigned with the same reference sign, and description thereof is hereinafter appropriately omitted.

In FIG. 6, in the model generation process of FIG. 5, each of the speech section estimation processing and the speech direction estimation processing, which are signal processing other than the base signal processing, is selected as the signal processing of interest, and the learning model for performing the signal processing of interest is selected as the model of interest.

As the signal processing of interest, a plurality of signal processing can be selected instead of one signal processing, and a learning model for performing the plurality of signal processing can be selected as the model of interest.

For example, two types of signal processing of the speech section estimation processing and the speech direction estimation processing can be selected as the signal processing of interest, and a learning model that performs both the speech section estimation processing and the speech direction estimation processing can be selected as the model of interest.

In this case, the learning unit 42 transfers the transfer portion 51A of the learning model 51 that performs the speech enhancement processing as the base model after learning as the transfer portion 61A of the learning model 61 that performs two signal processing of the speech section estimation processing and the speech direction estimation processing as the model of interest.

Then, the learning unit 42 learns the non-transfer portion 61B other than the transfer portion 61A of the learning model 61 that performs two signal processing of the speech section estimation processing and the speech direction estimation processing as the model of interest.

The learning of the non-transfer portion 61B of the learning model 61 is performed by giving learning data to the input and output of the learning model 61 and fixing the transfer portion 61A of the learning model 61.

The learning of the non-transfer portion 61B of the learning model 61 that performs two types of signal processing of the speech section estimation processing and the speech direction estimation processing can be performed by using the technology described in Document A or the multi-task learning, for example.

The learning of the learning model 51 and the learning model 61 (the non-transfer portion 61B thereof) is independently performed. Therefore, it is possible to perform appropriate learning so as to obtain necessary performance for each of the speech enhancement processing performed by the learning model 51 and the two signal processing of the speech section estimation processing and the speech direction estimation processing performed by the learning model 61.

After learning the learning model 51 and the non-transfer portion 61B of the learning model 61, the combination unit 44 combines the non-transfer portion 61B with the transfer portion 51A of the learning model 51. As a result, a combined model in which the non-transfer portion 61B of the learning model 61 is combined with the learning model 51 is generated.

In such a combined model, the transfer portion 51A and the non-transfer portion 51B constitute the learning model 51 that performs the speech enhancement processing, and the transfer portion 51A and the non-transfer portion 61B constitute the learning model 61 that performs two types of signal processing of the speech section estimation processing and the speech direction estimation processing.

Even in such a combined model, similarly to the combined model 50 of FIG. 7, it is possible to suppress useless calculation and to reduce the overall calculation amount as compared with the cases of FIGS. 1 and 2.

For example, in the case of FIG. 2, it is necessary to calculate the transfer portions 51A and 61A and the non-transfer portions 51B and 61B in FIG. 8.

On the other hand, in the case of the combined model generated by performing the learning described in FIG. 8, it is only necessary to perform calculations for the transfer portion 51A and the non-transfer portions 51B and 61B, and the overall amount of calculations can be reduced by the amount of calculation for the transfer portion 61A.

Furthermore, by adjusting the non-transfer portion 51B, the performance of the speech enhancement processing performed by the learning model 51 can be adjusted independently of the performance of the two signal processing of the speech section estimation processing and the speech direction estimation processing performed by the learning model 61.

Moreover, by adjusting the non-transfer portion 61B, the performance of the two signal processing of the speech section estimation processing and the speech direction estimation processing performed by the learning model 61 can be adjusted independently of the performance of the speech enhancement processing performed by the learning model 51.

However, the performance of each of the two signal processing of the speech section estimation processing and the speech direction estimation processing performed by the learning model 61 cannot be adjusted independently of the performance of the another signal processing.

Note that, here, in the model generation process of FIG. 5, a plurality of pieces of signal processing (for example, two types of signal processing of the speech section estimation processing and the speech direction estimation processing) is selected as the signal processing of interest, and a learning model for performing the plurality of pieces of signal processing is selected as the model of interest.

In the model generation process of FIG. 5, in addition to the signal processing of interest, a plurality of pieces of signal processing can be selected as the base signal processing, and a learning model for performing the plurality of pieces of signal processing can be selected as the base model. In this case, the performance of the plurality of signal processing as the base signal processing can be adjusted independently of the performance of another signal processing other than the base signal processing. However, the performance of certain signal processing among the plurality of signal processing as the base signal processing cannot be adjusted independently of the performance of the another signal processing as the base signal processing. Note that in a case where one signal processing is selected as the signal processing of interest regardless of whether one signal processing or a plurality of signal processing is selected as the base signal processing, the performance of the one signal processing as the signal processing of interest can be adjusted independently of the performance of the another signal processing.

### <Example of Adjustment of Performance of Signal Processing Performed by Combined Model>

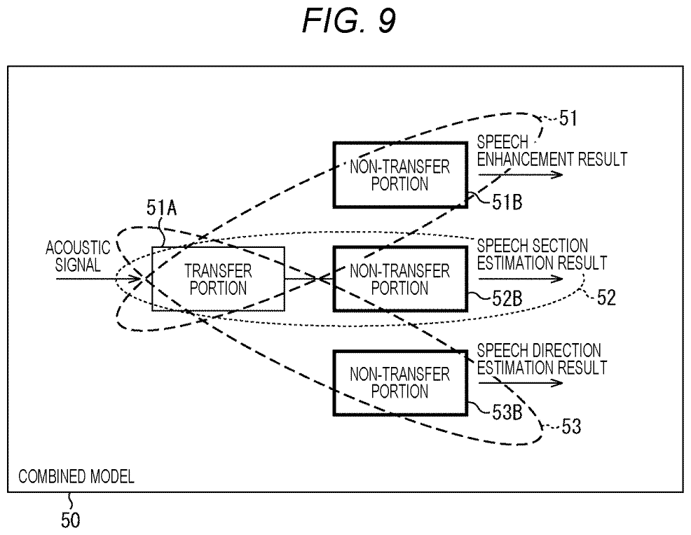

FIG. 9 is a diagram illustrating an example of adjustment of performance of signal processing performed by the combined model.

The learning unit 42 can adjust the performance of the signal processing performed by the combined model generated in the combination unit 44.

For the combined model, the performance of the signal processing performed by the learning model including the transfer portion and the non-transfer portion can be adjusted independently of the performance of the signal processing performed by another learning model by adjusting the non-transfer portion.

FIG. 9 illustrates a combined model 50 similar to that illustrated in FIG. 7.

In the drawing, the performance of each of the speech enhancement processing, the speech section estimation processing, and the speech direction estimation processing can be adjusted independently by adjusting each of the non-transfer portions 51B to 53B surrounded by thick frames.

During development of a product equipped with the combined model 50, there may be a need to adjust (improve) the performance of any of the speech enhancement processing, the speech section estimation processing, and the speech direction estimation processing.

For example, in a case where speech recognition processing is performed in the subsequent stage of the speech enhancement processing using the speech enhancement result obtained by the speech enhancement processing as an input, there is a case where it is desired to adjust the performance of the speech enhancement processing so as to obtain a speech enhancement result with which the accuracy of the speech recognition becomes high.

Furthermore, for example, there is a case where it is desired to adjust the performance of the speech section estimation processing so as to increase the estimation accuracy of the speech section of a specific voice quality.

For the combined model 50, the performance of the speech enhancement processing can be adjusted without changing the performance of another signal processing, that is, the speech section estimation processing and the speech direction estimation processing by adjusting the non-transfer portion 51B of the learning model 51 that performs the speech enhancement processing.

Furthermore, regarding the combined model 50, the performance of the speech section estimation processing can be adjusted without changing the performance of another signal processing, that is, the speech enhancement processing and the speech direction estimation processing by adjusting the non-transfer portion 52B of the learning model 52 that performs the speech section estimation processing.

In a case where a learning model that shares some model parameters, such as the combined model 50, is generated by multi-task learning, it is necessary to perform relearning or joint training of the entire learning model when adjusting performance of a certain task (signal processing). Moreover, the relearning or joint training affects the performance of other tasks.

On the other hand, for the combined model 50, in a case where the performance of certain specific signal processing is adjusted, it is only necessary to perform relearning or joint training of only the non-transfer portion of the learning model that performs the specific signal processing. Therefore, the performance of the specific signal processing can be adjusted at a low cost (small calculation amount) as compared with the case of multi-task learning. Moreover, relearning or joint training of the non-transfer portion of the learning model that performs specific signal processing does not affect the performance of the another signal processing performed by the combined model 50.

### <Specific Examples of Transfer Portion and Non-Transfer Portion>

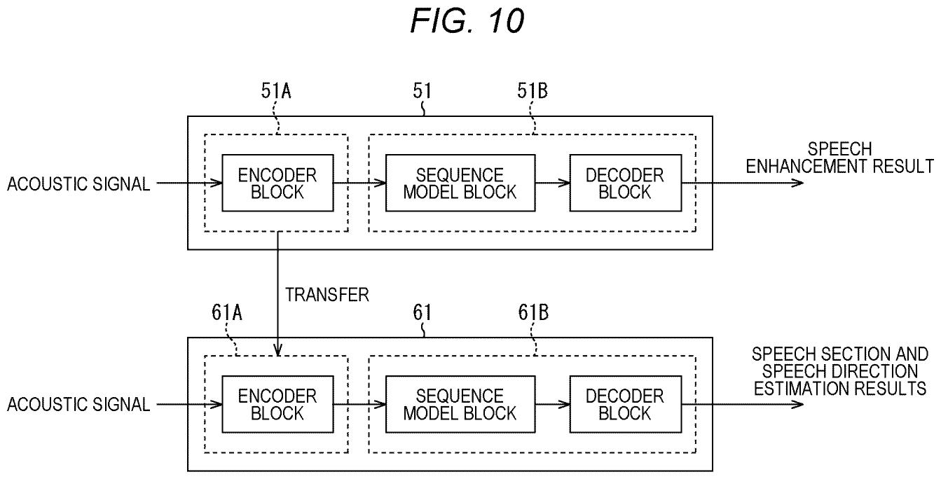

FIG. 10 is a diagram illustrating a specific example of a transfer portion and a non-transfer portion.

FIG. 10 illustrates specific examples of the transfer portion and the non-transfer portion in a case where the learning described in FIG. 8 is performed.

As the learning models 51 and 61, for example, a neural network such as a DNN can be adopted.

For example, as an architecture of a DNN that performs speech processing such as the speech enhancement processing, the speech section estimation processing, and the speech direction estimation processing, for example, there is a structure in which an encoder block, a sequence model block, and a decoder block are disposed from an input layer side toward an output layer side.

The encoder block has a function (role) of projecting an input to the DNN onto a predetermined space that can be easily processed by the DNN. The sequence model block has a function of processing the signal from the encoder block in consideration of being a time-series signal (information). The decoder block has a function of projecting a signal from the sequence model block onto a space of an output of the DNN.

In a case where the learning models 51 and 61 are constituted by DNNs having an encoder block, a sequence model block, and a decoder block, for example, the encoder block can be set as a transfer portion. In this case, the sequence model block and the decoder block are non-transfer portions.

In a case where the encoder block is a transfer portion, learning of the learning model 51 is performed, and the encoder block as the transfer portion 51A of the learning model 51 after learning is transferred to the encoder block as the transfer portion 61A of the learning model 61. Then, the sequence model block and the decoder block as the non-transfer portion 61B of the learning model 61 are learned.

Thereafter, by combining the sequence model block and the decoder block as the non-transfer portion 61B of the learning model 61 with the encoder block as the transfer portion 51A of the learning model 51, a combined model in which the non-transfer portion 61B of the learning model 61 is combined with the learning model 51 is generated.

During the development, for example, in a case where it is desired to adjust the performance of the speech enhancement processing, the performance of the speech enhancement processing can be adjusted without changing the performance of the speech section estimation processing and the speech direction estimation processing by performing relearning or the like of the sequence model block and the decoder block as the non-transfer portion 51B of the learning model 51 while fixing (the model parameters of) the encoder block as the transfer portion 51A.

Furthermore, for example, in a case where it is desired to adjust the performance of both the speech section estimation processing and the speech direction estimation processing, the performance of both the speech section estimation processing and the speech direction estimation processing can be adjusted without changing the performance of the speech enhancement processing by performing relearning or the like of the sequence model block and the decoder block as the non-transfer portion 61B of the learning model 61 while fixing the encoder block as the transfer portion 51A (61A).

### <Another Example of Adjustment of Performance of Signal Processing Performed by Combined Model>

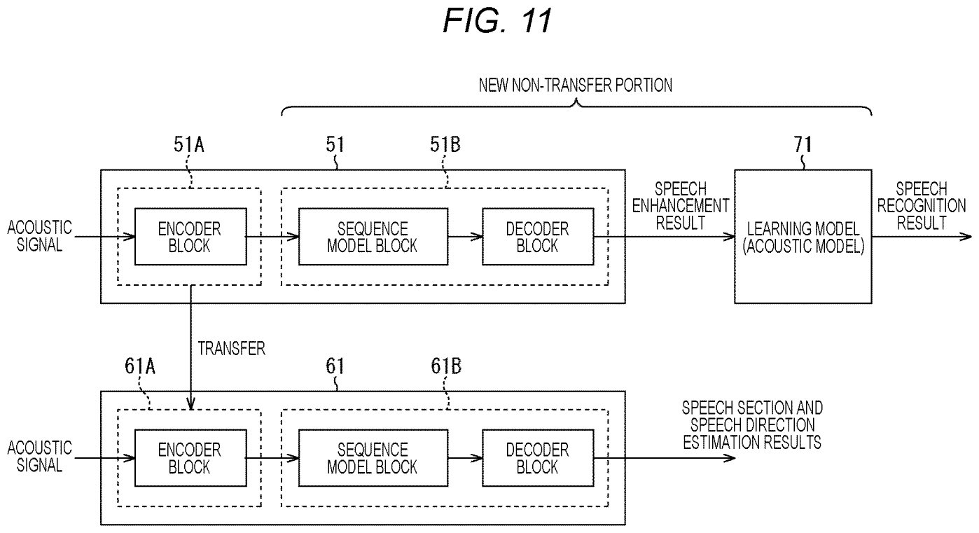

FIG. 11 is a diagram illustrating another example of the adjustment of the performance of the signal processing performed by the combined model.

FIG. 11 illustrates an example of adjustment of the performance of the speech enhancement processing after the learning described in FIG. 10 is performed.

In a case where the speech recognition processing using an acoustic model is performed at the subsequent stage of the speech enhancement processing using the speech enhancement result obtained by the speech enhancement processing as an input, the acoustic model as a learning model 71 for performing the speech recognition processing is equivalently connected to the subsequent stage of the learning model 51 for performing the speech enhancement processing.

The acoustic model as the learning model 71 is, for example, a learning model that receives information of a speech signal as a speech enhancement result as an input and outputs (the likelihood of) a character string representing a phoneme of speech corresponding to the speech signal.

In a case where the learning model 71 is connected to the subsequent stage of the learning model 51 of the combined model generated by performing the learning described in FIG. 10, appropriate accuracy may not be obtained as the accuracy of the speech recognition result of the learning model 71.

In this case, the learning unit 42 can add the learning model 71 (further another learning model) to the non-transfer portion 51B of the learning model 51, and perform relearning or joint training as adjustment of a new non-transfer portion configured by the non-transfer portion 51B and the learning model 71 so as to obtain appropriate accuracy of the speech recognition result.

The adjustment of the new non-transfer portion configured by the non-transfer portion 51B and the learning model 71 is performed by giving learning data to the input and output of the learning model to which the learning model 71 is connected (added) to the subsequent stage of the learning model 51 and fixing the transfer portion 51A.

By adjusting the new non-transfer portion including the non-transfer portion 51B and the learning model 71, the performance of the speech enhancement processing and the speech recognition processing is adjusted so that a speech recognition result with appropriate accuracy can be obtained.

In a case where the learning model 71 is added to the non-transfer portion 51B of the learning model 51, the finally obtained combined model is a learning model that simultaneously outputs the speech recognition result, and the speech section and the speech direction estimation results.

Such a combined model that simultaneously outputs the speech recognition result, and the speech section and the speech direction estimation results can be used (mounted) in, for example, an entertainment robot.

The entertainment robot executes various interactions with the user by integrating (comprehensively using), for example, an acoustic signal observed by a microphone and a signal observed by a camera or other sensors.

For example, when the user utters a specific word toward the entertainment robot from a position away from the entertainment robot, the entertainment robot recognizes the position (direction) of the user and executes an interaction to approach the user.

Such an interaction can be realized by integrating the speech section estimation result, the speech direction estimation result, and the speech recognition result.

The speech section estimation result can be obtained by performing the speech section estimation processing, and the speech direction estimation result can be obtained by performing the speech direction estimation processing. The speech recognition result can be obtained by performing the speech enhancement processing and the speech recognition processing.

In a case where each of the signal processing of the speech section estimation processing, the speech direction estimation processing, the speech enhancement processing, and the speech recognition processing is performed using an individual learning model, for example, as described with reference to FIG. 1, redundant calculation, that is, useless calculation is performed in the speech section estimation processing, the speech direction estimation processing, and the speech enhancement processing. As a result, the overall calculation amount of the speech section estimation processing, the speech direction estimation processing, the speech enhancement processing, and the speech recognition processing increases, and the speech section estimation processing, the speech direction estimation processing, the voice enhancement processing, and the speech recognition processing may not be able to be executed at a sufficient speed with the calculation resources of the entertainment robot.

On the other hand, in a case where all the processing of the speech section estimation processing, the speech direction estimation processing, the speech enhancement processing, and the speech recognition processing are performed using the (one) learning model that performs a plurality of signal processing, for example, as described with reference to FIG. 3, it is possible to suppress useless calculation. As a result, the overall calculation amount of the speech section estimation processing, the speech direction estimation processing, the speech enhancement processing, and the speech recognition processing is reduced, and the speech section estimation processing, the speech direction estimation processing, the voice enhancement processing, and the speech recognition processing can be executed at a sufficient speed (real time) even with the calculation resources of the entertainment robot.

However, as described with reference to FIG. 3, in a case where all the processing of the speech section estimation processing, the speech direction estimation processing, the speech enhancement processing, and the speech recognition processing are performed using a learning model that performs a plurality of signal processing, the performance of any one of the signal processing may be insufficient.

For example, in a case where the performance of the speech section estimation processing is insufficient, a section that is not a speech section is erroneously detected as a speech section, and as a result, a sound that is not a speech is erroneously detected as a speech and is erroneously recognized as some kind of word. In this case, the entertainment robot performs an unnatural (unexpected) action.

Specifically, for example, in a case where the opening/closing sound of opening/closing the door indoors is erroneously detected as a sound, the entertainment robot executes an action of approaching the door. In this case, reality and the like of the entertainment robot may be impaired.

In a case where all the processing of the speech section estimation processing, the speech direction estimation processing, the speech enhancement processing, and the speech recognition processing are performed using a learning model that performs a plurality of signal processing, there may be a problem that performance of one of the speech section estimation processing, the speech direction estimation processing, the speech enhancement processing, and the speech recognition processing or a plurality of signal processing cannot be independently adjusted (tuned) in the development phase.

For example, as described above, in a case where relearning is attempted by adjusting the learning data so as not to erroneously detect the section of the opening and closing sound of the door as the speech section, even if the performance of the speech section estimation processing is improved, the performance of the another signal processing performed by the learning model, that is, the speech direction estimation processing, the speech enhancement processing, and the speech recognition processing changes.

In a case where the evaluation of the performance of the speech direction estimation processing, the speech enhancement processing, and the speech recognition processing is completed and it is not desired to change the performance, in relearning for improving the performance of the speech section estimation processing, a change in the performance of the speech direction estimation processing, the voice enhancement processing, and the speech recognition processing is an obstacle to development.

In addition to the case of improving the performance of the speech section estimation processing, in a case of improving the performance of the another signal processing, for example, in a case where some speech is likely to be erroneously recognized, even in a case of improving the performance of the speech enhancement processing and the speech recognition processing so as to suppress the erroneous recognition, a similar failure occurs.

According to the combined model obtained by adding the learning model 71 to the non-transfer portion 51B of the learning model 51 described in FIG. 11, the amount of calculation can be reduced to a sufficient extent with the calculation resource of the entertainment robot. Moreover, by independently adjusting the performance of the signal processing, for example, it is possible to suppress erroneous detection of the speech section and erroneous recognition of the speech, and to suppress the entertainment robot from executing an unnatural action of approaching the door in response to the opening/closing sound of the door.

### <Example of Generation of New Combined Model by Adding Non-Transfer Portion of Another Learning Model to Combined Model>

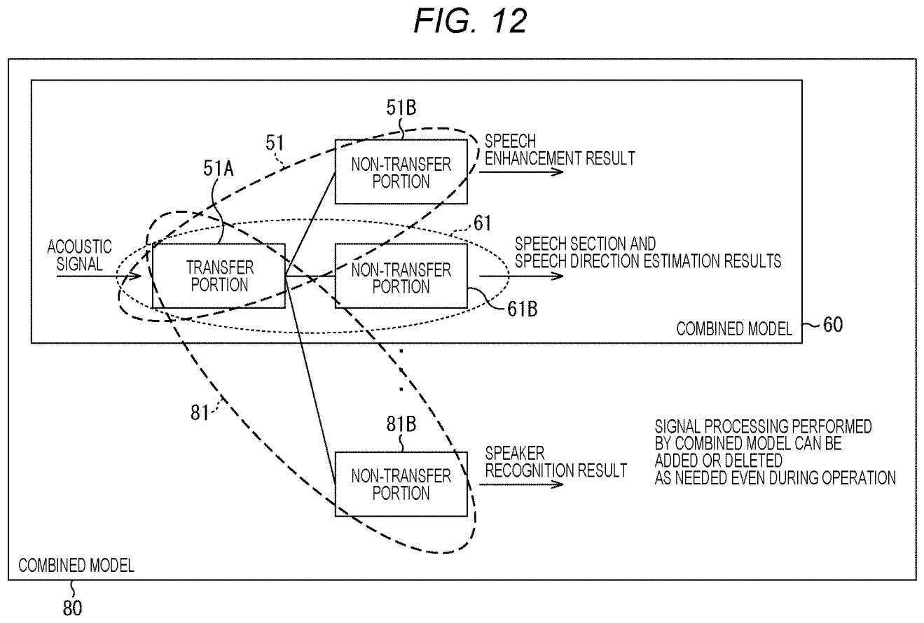

FIG. 12 is a diagram illustrating an example of generation of a new combined model by adding a non-transfer portion of another learning model to the combined model.

The signal processing performed by the combined model is not limited to the speech enhancement processing, the speech section estimation processing, the speech direction estimation processing, and the speech recognition processing, and various signal processing for an acoustic signal including a speech signal can be adopted.

For example, processing of detecting a fundamental frequency (pitch frequency) or a formant frequency of speech, speaker recognition processing of recognizing a speaker, or the like can be adopted as the signal processing performed by the combined model.

Furthermore, the signal processing performed by the combined model can be added or deleted not only before the provision of the product or the service using the combined model is started but also after the provision of the product or the service using the combined model is started.

FIG. 12 illustrates an example of a new combined model generated by adding a non-transfer portion such as a learning model for performing speaker recognition processing to a combined model for performing speech enhancement processing, speech section estimation processing, and speech direction estimation processing.

In FIG. 12, for example, the learning described in FIG. 8 is performed, and the non-transfer portion 61B is combined with the transfer portion 51A of the learning model 51, so that the combined model 60 in which the non-transfer portion 61B of the learning model 61 is combined with the learning model 51 is generated.

For example, in a case where speaker recognition processing is added as the signal processing performed by the combined model 60, the transfer portion 51A of the learning model 51 that performs the speech enhancement processing as the base model is transferred to the learning model 81 that performs the speaker recognition processing.

Then, the learning unit 42 learns the non-transfer portion 81B of the learning model 81 that performs the speaker recognition processing.

The learning of the non-transfer portion 81B of the learning model 81 is performed by giving learning data to the input and output of the learning model 81 and fixing the transfer portion (transfer portion 51A) of the learning model 81.

After learning the non-transfer portion 81B of the learning model 81, the combination unit 44 combines the non-transfer portion 81B to the transfer portion 51A of the learning model 51. As a result, a new combined model 80 in which the non-transfer portion 81B of the learning model 81 is added to the combined model 60 is generated.

In a case where speaker recognition processing is added after provision of a product or a service using the combined model 60 is started, the new combined model 80 generated as described above is only required to be transmitted to a provider of the product or the service and used instead of the combined model 60.

In addition, for example, the non-transfer portion 81B of the learning model 81 after learning can be transmitted to the provider of the product or service, and the provider of the product or service can generate the combined model 80 in which the non-transfer portion 81B of the learning model 81 is added to the combined model 60.

Note that the signal processing performed by the combined model can be deleted by deleting, from the combined model, the non-transfer portion of the learning model that performs the signal processing to be deleted.

### <Generation of Combined Model for Each Type of Signal Targeted by Target Information>

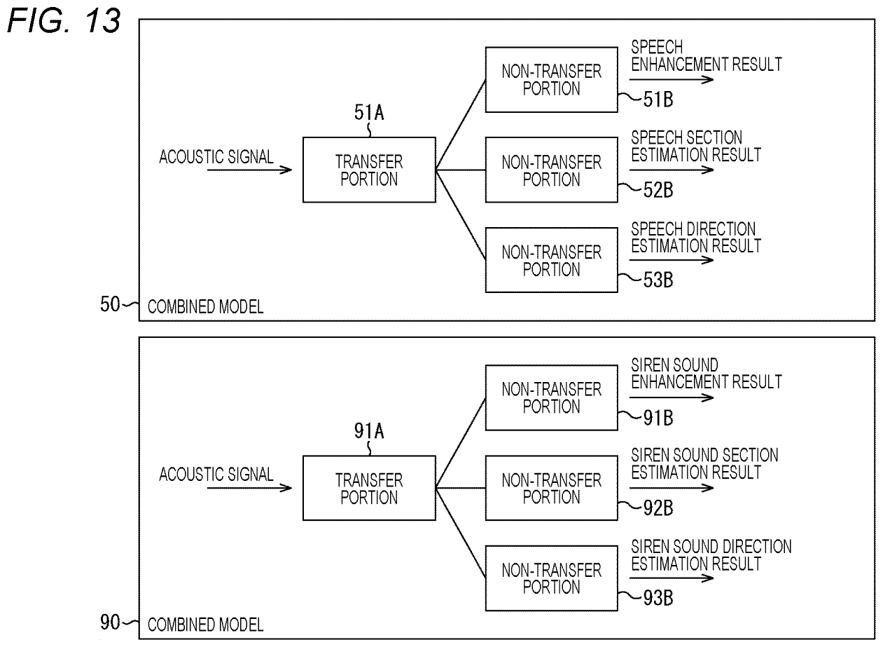

FIG. 13 is a diagram illustrating an example of generation of a combined model for each type of signal targeted by the target information.

In the above, as the signal processing performed by the combined model, signal processing for generating information regarding a speech signal as target information, such as speech enhancement processing, speech section estimation processing, speech direction estimation processing, and speech recognition processing, has been adopted.

As the signal processing performed by the combined model, signal processing of generating information regarding an acoustic signal other than a speech signal as target information can be adopted.

For example, signal processing for generating information regarding a siren sound as target information can be adopted as signal processing performed by the combined model.

Examples of the signal processing for generating the information regarding the siren sound as the target information include siren sound enhancement processing, siren sound section estimation processing, and siren sound direction estimation processing.

The siren sound enhancement processing is processing of removing a signal of a sound other than the siren sound from the acoustic signal and generating information of the signal of the siren sound as target information.

The siren sound section estimation processing is processing of generating, from an acoustic signal, information on a siren sound section in which a siren sound exists as target information.

The siren sound direction estimation processing is processing of generating, from an acoustic signal, information on an arrival direction (siren sound direction) in which a siren sound arrives as target information.

When transfer is performed from one learning model to the another learning model between two learning models having different types of target information signals, that is, two learning models that output target information having different target information signals, there is a possibility that the performance of signal processing performed by the another learning model is not sufficient due to the influence of the transfer.

For example, when a transition is performed from a learning model in which a signal targeted by the target information is an audio signal to a learning model in which a signal targeted by the target information is a signal of a siren sound, there is a possibility that it is difficult to improve the performance of the learning model in which a signal targeted by the target information is a signal of a siren sound due to the influence of the transfer portion.

Therefore, the transfer of the transfer portion of the learning model can be performed for each type of the signal targeted by the target information, for example, for each signal of the speech signal or the siren sound targeted by the target information, and the combined model can also be generated for each type of the signal targeted by the target information.

FIG. 13 illustrates an example of a combined model for each type of signal as a target of the target information in a case where the transfer portion of the learning model is transferred for each type of signal as a target of the target information to generate the combined model.

In FIG. 13, the combined model 50 is a combined model similar to that in FIG. 7 in a case where a signal to be a target of the target information is a speech signal, generated as described in FIG. 6.

Furthermore, the combined model 90 is a combined model generated similarly to the combined model 50 in a case where a target signal of the target information is a signal of a siren sound.

The combined model 90 includes a transfer portion 91A and non-transfer portions 91B to 93B.

In the combined model 90, the transfer portion 91A and the non-transfer portion 91B constitute a learning model for performing the siren sound enhancement processing. Then, the transfer portion 91A and the non-transfer portion 92B constitute a learning model for performing the siren sound section estimation processing, and the transfer portion 91A and the non-transfer portion 93B constitute a learning model for performing the siren sound direction estimation processing.

The combined model 90 can be used, for example, in an application that detects a siren sound of an emergency vehicle and notifies a driver driving the vehicle of a clear siren sound and a direction of the emergency vehicle.

Furthermore, by using both the combined models 50 and 90, it is possible to configure a system corresponding to both speech and a siren sound.

For other types of signals targeted by the target information, a system corresponding to any type of sound can be configured by generating a combined model.

<Embodiment of Multi-Signal Processing Device to which Present Technology is Applied>

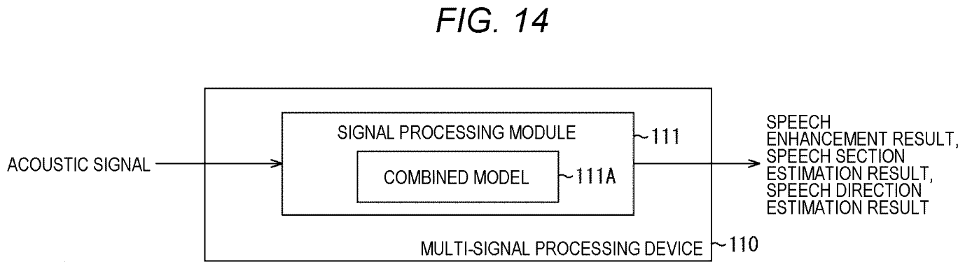

FIG. 14 is a block diagram illustrating a configuration example of an embodiment of a multi-signal processing device to which the present technology is applied.

In FIG. 14, a multi-signal processing device 110 includes a signal processing module 111. For example, similarly to the multi-signal processing device 10 in FIG. 1, the multi-signal processing device 110 performs three signal processing of speech enhancement processing, speech section estimation processing, and speech direction estimation processing on the acoustic signal.

The signal processing module 111 includes, for example, a combined model 111A that is a neural network or another mathematical model. The combined model 111A is a learned learning model that receives the acoustic signal (a feature amount of the acoustic signal) as an input and outputs information of a speech signal, a speech section, and an arrival direction included in the acoustic signal. Therefore, the combined model 111A is a learning model that performs a plurality of pieces of signal processing, that is, three pieces of signal processing of the speech enhancement processing, the speech section estimation processing, and the speech direction estimation processing.

The signal processing module 111 inputs the acoustic signal to the combined model 111A, and outputs information of the speech signal, the speech section, and the arrival direction output from the combined model 111A in response to the input of the acoustic signal as the speech enhancement result, the speech section estimation result, and the speech direction estimation result.

The combined model 111A is, for example, the combined model 50 (FIG. 7) generated by the model generation device 40, and as described with reference to FIG. 7, the calculation amount using the combined model 111A is smaller than that in the cases of FIGS. 1 and 2. Therefore, in a case where the multi-signal processing device 110 is mounted on an edge device such as an entertainment robot having few resources, it is possible to execute the speech enhancement processing, the speech section estimation processing, and the speech direction estimation processing at a sufficient speed.

Moreover, even after the multi-signal processing device 110 is mounted on the edge device, the performance of each of the speech enhancement processing, the speech section estimation processing, and the speech direction estimation processing can be adjusted independently.

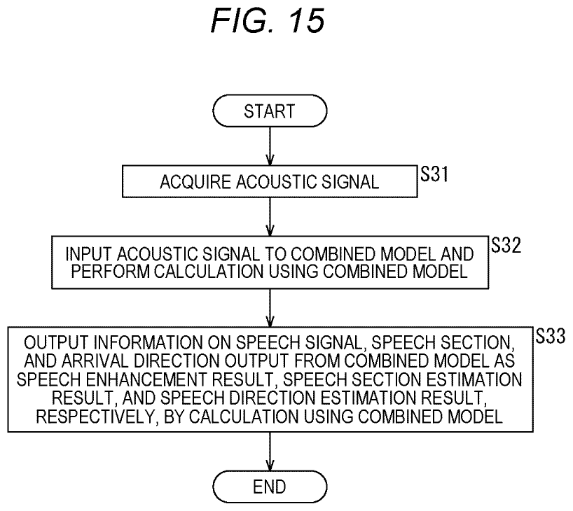

FIG. 15 is a flowchart illustrating an example of a process of the multi-signal processing device 110 in FIG. 14.

In step S31, the signal processing module 111 of the multi-signal processing device 110 acquires the acoustic signal, and the process proceeds to step S32.

In step S32, the signal processing module 111 performs signal processing using the combined model 111A on the acoustic signal. That is, the signal processing module 111 inputs the acoustic signal to the combined model 111A and performs calculation using the combined model 111A, and the process proceeds from step S32 to step S33.

In step S33, the signal processing module 111 outputs the information on the speech signal, the speech section, and the arrival direction output from the combined model as the speech enhancement result, the speech section estimation result, and the speech direction estimation result, respectively, by the calculation using the combined model, and the process ends.

The present technology can be applied to signal processing or the like for a signal corresponding to reception of light output from an optical sensor that receives light, for example, an image signal, a distance signal, or the like, in addition to signal processing for an acoustic signal.

Furthermore, the present technology can be applied to a learning model other than the neural network.

Note that Patent Document 1 describes that model parameters are shared by the multi-task learning, but does not describe a specific implementation method regarding a case of performing three types of signal processing of the speech enhancement processing, the speech section estimation processing, and the speech direction estimation processing. Moreover, Patent Document 1 does not describe a method of independently adjusting and balancing performance of each task (signal processing) and a method of performing relearning for each task in the multi-task learning.

<Description of Computer Applied with Present Technology>

Next, a series of processing of the model generation device 40 and the multi-signal processing device 110 described above can be performed by hardware or software. In a case where the series of processing is performed by software, a program constituting the software is installed in a general-purpose computer or the like.

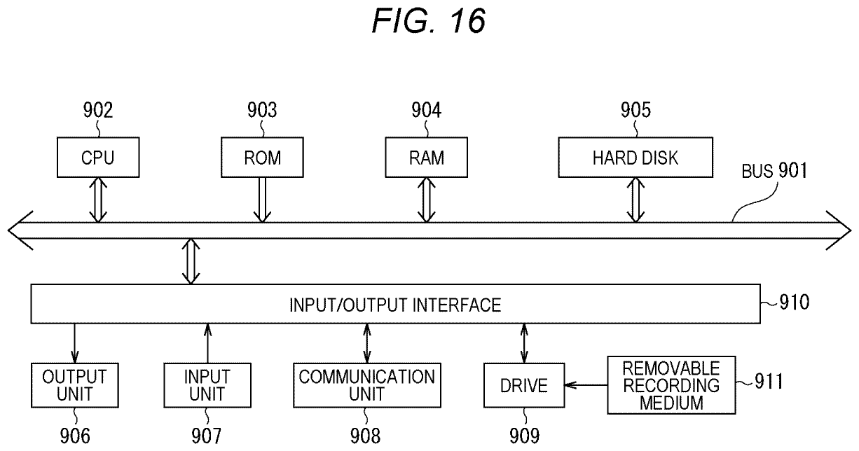

FIG. 16 is a block diagram illustrating a configuration example of an embodiment of a computer in which a program for executing the above-described series of processing is installed.

The program can be pre-recorded on a hard disk 905 or ROM 903 as a recording medium incorporated in the computer.

Alternatively, the program can be stored (recorded) in a removable recording medium 911 driven by a drive 909. Such a removable recording medium 911 can be provided as so-called package software. Here, the removable recording medium 911 includes, for example, a flexible disk, a compact disc read only memory (CD-ROM), a magneto optical (MO) disk, a digital versatile disc (DVD), a magnetic disk, a semiconductor memory, and the like.

Note that the program can be installed in the computer from the removable recording medium 911 as described above, or can be downloaded to the computer via a communication network or a broadcast network and installed in the built-in hard disk 905. That is, for example, the program can be wirelessly transferred from a download site to the computer via an artificial satellite for digital satellite broadcasting, or can be transferred by wire to the computer via a network such as a local area network (LAN) or the Internet.

The computer incorporates a central processing unit (CPU) 902, and an input/output interface 910 is connected to the CPU 902 via a bus 901.

If a command is input by a user through the input/output interface 910 by operating an input unit 907 or the like, the CPU 902 executes the program stored in the read only memory (ROM) 903 accordingly. Alternatively, the CPU 902 loads the program stored in the hard disk 905 into a random access memory (RAM) 904 and executes it.

Thus, the CPU 902 performs the processing according to the above-described flowchart or the processing performed according to the above-described configuration of the block diagram. Then, as necessary, the CPU 902 causes a processing result to be outputted from an output unit 906 or transmitted from a communication unit 908 via the input/output interface 910, for example, and further to be recorded on the hard disk 905, and the like.

Note that the input unit 907 includes a keyboard, a mouse, a microphone, and the like. Furthermore, the output unit 906 includes a liquid crystal display (LCD), a speaker, and the like.

Here, in the present specification, the processing to be performed by the computer in accordance with the program are not necessarily performed in time series according to the orders described in the flowcharts. In other words, the processing to be performed by the computer in accordance with the program includes processing to be executed in parallel or independently (for example, parallel processing or object-based processing). Furthermore, the program may be processed by one computer (one processor) or processed in a distributed manner by a plurality of computers. Moreover, the program may be transferred to a distant computer to be executed.

Moreover, in the present description, a system means a set of a plurality of configuration elements (devices, modules (parts), and the like), and it does not matter whether or not all the configuration elements are in the same housing. Therefore, a plurality of devices housed in separate housings and connected to each other via a network and one device in which a plurality of modules is housed in one housing are both systems.

Note that the embodiments of the present technology are not limited to the above-described embodiments, and various changes can be made without departing from the gist of the present technology.

For example, the present technology may be embodied in cloud computing in which a function is shared and executed by a plurality of devices via a network.

Furthermore, each step described in the flowchart described above can be performed by one device or can be shared and performed by a plurality of devices.

Moreover, in a case where a plurality of pieces of processing is included in one step, the plurality of pieces of processing included in the one step can be executed by one device or executed by a plurality of devices in a shared manner. Furthermore, the effects described in the present description are merely examples and are not limited, and other effects may be provided.

Note that the present technology can have the following configurations.

<1>

A model generation device including:
a learning unit that
   learns a transferable learning model, transfers a part of the learning model to another transferable learning model, and
   learns a non-transfer portion other than a transfer portion of the another learning model; and
a combination unit that generates a combined model in which the non-transfer portion of the another learning model is combined with the learning model.
   <2>

The model generation device according to <1>, in which the learning model includes a learning model that outputs a larger amount of information than the another learning models.

<3>

The model generation device according to <1> or <2>, in which
the learning model and the another learning model include learning models that perform signal processing of generating target information as a target from an acoustic signal.
   <4>

The model generation device according to <3>, in which
the learning model includes a learning model that performs speech enhancement processing of generating, from the acoustic signal, information on a speech signal as the target information, and
the another learning model includes a learning model that performs
   speech section estimation processing of generating, from the acoustic signal, information on a speech section in which the speech signal exists as the target information, or
   speech direction estimation processing of generating, from the acoustic signal, information on an arrival direction in which speech arrives as the target information.
      <5>

The model generation device according to <3>, in which
the learning model includes a learning model that performs speech enhancement processing of generating, from the acoustic signal, information on a speech signal as the target information, and
the another learning model includes a learning model that performs both of
   speech section estimation processing of generating, from the acoustic signal, information on a speech section in which the speech signal exists as the target information, and
   speech direction estimation processing of generating, from the acoustic signal, information on an arrival direction in which speech arrives as the target information.
      <6>

The model generation device according to <5>, in which
the another learning model includes a learning model that outputs a three-dimensional vector including results of both the speech section estimation processing and the speech direction estimation processing.
   <7>

The model generation device according to any one of <1> to <6>, in which
each of the learning model and the another learning model includes a neural network.
   <8>

The model generation device according to <7>, in which
the learning unit transfers a part of an input layer side of the neural network.
   <9>

The model generation device according to <8>, in which
the learning model includes an encoder block that projects an input to the learning model onto a predetermined space on the input layer side, and
the learning unit transfers the encoder block.
   <10>

The model generation device according to any one of <1> to <9>, in which
the learning unit adjusts the non-transfer portion of the combined model.
   <11>

The model generation device according to <10>, in which
the learning unit adjusts a new non-transfer portion obtained by further adding another learning model to the non-transfer portion.
   <12>

The model generation device according to <11>, in which
the learning model includes a learning model that performs speech enhancement processing of generating, from an acoustic signal, information on a speech signal, and
the learning unit adjusts a new non-transfer portion obtained by adding an acoustic model to the non-transfer portion of the learning model.
   <13>

The model generation device according to any one of <1> to <12>, in which
the learning unit transfers a part of the learning model to another transferable learning model and learns a non-transfer portion other than a transfer portion of the another learning model, and
the combination unit generates a new combined model obtained by combining the non-transfer portion of the another learning model with the combined model.
   <14>

The model generation device according to any one of <1> to <13>, in which
the learning model includes a learning model that performs one or more pieces of signal processing.
   <15>

The model generation device according to any one of <1> to <14>, in which
the another learning model includes a learning model that performs one or more pieces of signal processing.
   <16>

A model generation method including:
performing learning of a transferable learning model;
transferring a part of the learning model to another transferable learning model, and performing learning of a non-transfer portion other than a transfer portion of the another learning model; and
generating a combined model in which the non-transfer portion of the another learning model is combined with the learning model.
   <17>

A program for causing a computer to function as:
a learning unit that
   learns a transferable learning model, transfers a part of the learning model to another transferable learning model, and
   learns a non-transfer portion other than a transfer portion of the another learning model; and
a combination unit that generates a combined model in which the non-transfer portion of the another learning model is combined with the learning model.
   <18>

A signal processing device including
a signal processing unit that performs signal processing using a combined model obtained by combining a non-transfer portion other than a transfer portion of another transferable learning model with a transferrable learning model, the non-transfer portion having been learned by transferring a part of the transferable learning model to the another transferable learning model.
   <19>

A signal processing method including
performing signal processing using a combined model obtained by combining a non-transfer portion other than a transfer portion of another transferable learning model with a transferrable learning model, the non-transfer portion having been learned by transferring a part of the transferable learning model to the another transferable learning model.
   <20>

A program for causing a computer to function as
a signal processing unit that performs signal processing using a combined model obtained by combining a non-transfer portion other than a transfer portion of another transferable learning model with a transferrable learning model, the non-transfer portion having been learned by transferring a part of the transferable learning model to the another transferable learning model.

### REFERENCE SIGNS LIST

10 Multi-signal processing device
11 Speech enhancement module
11A Learning model
12 Speech section estimation module
12A Learning model
13 Speech direction estimation module
13A Learning model
20 Multi-signal processing device
21 Speech section/direction estimation module
21A Learning model
30 Multi-signal processing device
31 Three processing module
31A Learning model
40 Model generation device
41 Learning data acquisition unit
42 Learning unit
43 Storage unit
44 Combination unit
50 Combined model
51 Learning model
51A Transfer portion
51B Non-transfer portion
52 Learning model
52A Transfer portion
52B Non-transfer portion
53 Learning model
53A Transfer portion
53B Non-transfer portion
60 Combined model
61 Learning model
61A Transfer portion
61B Non-transfer portion
71 Learning model
80 Combined model
81 Learning model
81B Non-transfer portion
90 Combined model
91A Transfer portion
91B, 92B, 93B Non-transfer portion
110 Multi-signal processing device
111 Signal processing module
111A Combined model
901 Bus
902 CPU
903 ROM
904 RAM
905 Hard disk
906 Output unit
907 Input unit
908 Communication unit
909 Drive
910 Input/output interface
911 Removable recording medium

1. A model generation device comprising:
a learning unit that
learns a transferable learning model, transfers a part of the learning model to another transferable learning model, and
learns a non-transfer portion other than a transfer portion of the another learning model; and
a combination unit that generates a combined model in which the non-transfer portion of the another learning model is combined with the learning model.

2. The model generation device according to claim 1, wherein
the learning model includes a learning model that outputs a larger amount of information than the another learning models.

3. The model generation device according to claim 1, wherein
the learning model and the another learning model include learning models that perform signal processing of generating target information as a target from an acoustic signal.

4. The model generation device according to claim 3, wherein
the learning model includes a learning model that performs speech enhancement processing of generating, from the acoustic signal, information on a speech signal as the target information, and
the another learning model includes a learning model that performs
speech section estimation processing of generating, from the acoustic signal, information on a speech section in which the speech signal exists as the target information, or
speech direction estimation processing of generating, from the acoustic signal, information on an arrival direction in which speech arrives as the target information.

5. The model generation device according to claim 3, wherein
the learning model includes a learning model that performs speech enhancement processing of generating, from the acoustic signal, information on a speech signal as the target information, and
the another learning model includes a learning model that performs both of
speech section estimation processing of generating, from the acoustic signal, information on a speech section in which the speech signal exists as the target information, and
speech direction estimation processing of generating, from the acoustic signal, information on an arrival direction in which speech arrives as the target information.

6. The model generation device according to claim 5, wherein
the another learning model includes a learning model that outputs a three-dimensional vector including results of both the speech section estimation processing and the speech direction estimation processing.

7. The model generation device according to claim 1, wherein
each of the learning model and the another learning model includes a neural network.

8. The model generation device according to claim 7, wherein
the learning unit transfers a part of an input layer side of the neural network.

9. The model generation device according to claim 8, wherein
the learning model includes an encoder block that projects an input to the learning model onto a predetermined space on the input layer side, and
the learning unit transfers the encoder block.

10. The model generation device according to claim 1, wherein
the learning unit adjusts the non-transfer portion of the combined model.

11. The model generation device according to claim 10, wherein
the learning unit adjusts a new non-transfer portion obtained by further adding another learning model to the non-transfer portion.

12. The model generation device according to claim 11, wherein
the learning model includes a learning model that performs speech enhancement processing of generating, from an acoustic signal, information on a speech signal, and
the learning unit adjusts a new non-transfer portion obtained by adding an acoustic model to the non-transfer portion of the learning model.

13. The model generation device according to claim 1, wherein
the learning unit transfers a part of the learning model to another transferable learning model and learns a non-transfer portion other than a transfer portion of the another learning model, and
the combination unit generates a new combined model obtained by combining the non-transfer portion of the another learning model with the combined model.

14. The model generation device according to claim 1, wherein
the learning model includes a learning model that performs one or more pieces of signal processing.

15. The model generation device according to claim 1, wherein
the another learning model includes a learning model that performs one or more pieces of signal processing.

16. A model generation method comprising:
performing learning of a transferable learning model;
transferring a part of the learning model to another transferable learning model, and performing learning of a non-transfer portion other than a transfer portion of the another learning model; and
generating a combined model in which the non-transfer portion of the another learning model is combined with the learning model.

17. A program for causing a computer to function as:
a learning unit that
learns a transferable learning model, transfers a part of the learning model to another transferable learning model, and
learns a non-transfer portion other than a transfer portion of the another learning model; and
a combination unit that generates a combined model in which the non-transfer portion of the another learning model is combined with the learning model.

18. A signal processing device comprising
a signal processing unit that performs signal processing using a combined model obtained by combining a non-transfer portion other than a transfer portion of another transferable learning model with a transferrable learning model, the non-transfer portion having been learned by transferring a part of the transferable learning model to the another transferable learning model.

19. A signal processing method comprising:
performing signal processing using a combined model obtained by combining a non-transfer portion other than a transfer portion of another transferable learning model with a transferrable learning model, the non-transfer portion having been learned by transferring a part of the transferable learning model to the another transferable learning model.

20. A program for causing a computer to function as
a signal processing unit that performs signal processing using a combined model obtained by combining a non-transfer portion other than a transfer portion of another transferable learning model with a transferrable learning model, the non-transfer portion having been learned by transferring a part of the transferable learning model to the another transferable learning model.
